(19) United States
(12) Patent Application Publication
(10) Pub. No.: US 2020/0377071 A1
(43) Pub. Date: Dec. 3, 2020

(54) BRAKE ACTUATOR FOR A RAIL VEHICLE

(71) Applicant: KNORR-BREMSE SYSTEME FÜR SCHIENENFAHRZEUGE GMBH, Munich (DE)

(72) Inventor: Achim VOLLMER, Taufkirchen (DE)

(21) Appl. No.: 16/643,352

(22) PCT Filed: Aug. 22, 2018
(86) PCT No.: PCT/EP2018/072627

§ 371 Date: Feb. 28, 2020

(30) Foreign Application Priority Data
Aug. 31, 2017 (DE) 10 2017 215 293.1

(51) Int. Cl. B60T 17/22; B61H 5/00; F16D 66/00; G06F 17/15

(52) U.S. Cl. CPC B60T 17/228; B61H 5/00; F16D 2066/005; G06F 17/156; B60T 2250/04; F16D 66/00

(57) ABSTRACT

A brake actuator for a rail vehicle has a sensor for detecting a braking force generated in the brake actuator, a sensor for detecting vibrations generated by the braking force in the brake actuator, and a control unit. The control unit is configured so as to generate a relationship between the speed of the rail vehicle with a generated braking force and a frequency of the vibrations generated by the braking force.

### CROSS REFERENCE AND PRIORITY CLAIM

This patent application is a U.S. National Phase of International Patent Application No. PCT/EP2018/072627 filed Aug. 22, 2018, which claims priority to German Patent Application No. 10 2017 215 293.1, the disclosure of which being incorporated herein by reference in their entireties.

### FIELD

Disclosed embodiments relate to a brake actuator for a rail vehicle, in particular a brake actuator for a rail vehicle which can function autonomously.

### BACKGROUND

In service braking operations, the required brake force in current rail vehicles is continuously calculated. This calculation is carried out on the basis of a traveled speed, a loading state, a braking requirement and availability of other braking systems.

In the case of emergency braking, a brake force which is intended to be applied locally by a brake actuator is defined, wherein this brake force is also dependent on the loading state and the speed. If a speed signal is disrupted or a communication between the brake actuator and a superordinate control system which transmits a speed signal is disrupted, however, the speed of the rail vehicle cannot be taken into account. For this reason, brakes are configured in a “fail-safe” manner so that in the event of braking a maximum possible speed is assumed, and the brakes are sized accordingly.

Such a sizing may, however, lead to oversizing with the result that there are produced increased costs. On the other hand, in the event of a failure, that is to say, the lack of speed information, there may be an extension of a safety-relevant brake path or thermal overloading of the brake equipment.

Furthermore, since speed sensors which are associated with each brake actuator are too expensive, the calculation of the brake force and actuation of the brake actuator in current brake systems is carried out on the scale of the carriage or bogie. A failure of speed information accordingly also always involves such a unit.

### SUMMARY

Disclosed embodiments provide brake actuators which eliminate the above disadvantages and which enable safe braking operations without being oversized.

### BRIEF DESCRIPTION OF THE FIGURES

Disclosed embodiments will now be explained with reference to an embodiment and the appended drawing, in which:

FIG. 1 is a schematic illustration of a rail vehicle with a brake actuator according to the disclosed embodiments.

### DETAILED DESCRIPTION

Disclosed embodiments provide a brake actuator that utilizes a production of a relationship between a speed of a rail vehicle with a brake force produced by a brake actuator and a frequency of oscillations produced by the brake force in the brake actuator and consequently a determination of the speed from the information items available on the brake actuator can be carried out only using additional sensors for detecting a brake force produced and a detection of oscillations produced by the brake force in the brake actuators.

Consequently, no redundant communication system has to be provided, or an oversizing of the brakes does not have to be carried out. If emergency braking is detected, a local brake actuator can further carry out a speed-dependent emergency braking without having to use a speed measured by speed sensors or a communication with a vehicle plane. Furthermore, a safety-relevant brake path can be improved using a low failure rate of the brake actuators.

In an advantageous development, the brake actuator has a pressing component, that is to say, for example, a brake liner which is configured to be pressed against a brake disk. As a result of the pressing of the pressing component on the brake disk, both the brake force and the oscillations produced by pressing on the brake disk can be simply detected in each brake actuator.

In another advantageous development, the brake force and the oscillations produced by the brake force are detected using a single sensor. Such a sensor supports, for example, a brake force generator within a brake caliper of the brake actuator counter to the brake force so that at the same time both the brake force and oscillations which are brought about, for example, using the friction of a pressing component on a brake disk or using an imbalance of the brake disk can be detected by this sensor. The number of components is thereby reduced and consequently the costs are reduced.

If the brake force generator during normal operation is advantageously connected to a superordinate control system which is configured to provide a speed signal of the rail vehicle, during normal operation this speed signal can be used to calculate the speed-dependent brake force and also an association of the speed with the brake force produced and oscillations produced by the brake force can be produced.

Advantageously, the control unit is configured to transmit a stop signal in the event of a stoppage of the rail vehicle. This stop signal which is independent of speed sensors can then be used, for example, by the superordinate control system to verify a safety-relevant stop signal, for example, for release in order to open doors. Since a large number of brake actuators are provided in the rail vehicle, an availability of the stop signal is high, whereas stop signals of speed sensors, for example, as a result of influences of electrical fields, may be unreliable.

In an advantageous development, the control unit is configured to establish portions of the frequency via a calculation of correlation factors via a calculation of the standard deviation, a “fast Fourier transformation—FFT” or a “discrete Fourier transformation—DFT”. It is thereby possible in a simple manner to calculate coefficients which can be used for determining the relationship between the speed of a rail vehicle with the brake force produced by the brake actuator and the frequency of the oscillations produced by the brake force in the brake actuator.

As a result of the method with the aspects according to claim 7, a production of a relationship between a speed of a rail vehicle with a brake force produced by a brake actuator and a frequency of oscillations produced by the brake force in the brake actuator and consequently a determination of the speed from the information items available on the brake actuator can be carried out only using additional sensors for detecting a brake force produced and detecting oscillations produced by the brake force in the brake actuators. Consequently, no redundant communication system has to be provided, or an oversizing of the brakes does not have to be carried out.

In an advantageous development of the method in which the speed signal is provided via the superordinate control system, this speed signal can be used during normal operation in order to calculate the speed-dependent brake force, and also an association of the speed with the brake force produced and the oscillations produced by the brake force can be produced.

The method may, using a conversion of the speed of the rail vehicle into a rotation speed of the brake disk, advantageously associate calculated frequencies with a speed of the brake disk.

If the operations to determine the speed of the rail vehicle are carried out with the brake actuator during service braking operations, it is possible to carry out the association without, for example, additional test braking operations.

In the response of an advantageous transmission of the stop signal when the rail vehicle stops, this stop signal which is independent of speed sensors can then be used, for example, by the superordinate control system to verify a safety-relevant stop signal, for example, for release for opening doors.

The portions of the frequency may advantageously be established via a calculation of correlation factors via the calculation of the standard deviation, the “fast Fourier transformation—FFT” or the “discrete Fourier transformation—DFT”. It is thereby possible in a simple manner to calculate coefficients which can be used for determining the relationship between the speed of a rail vehicle with the brake force produced by a brake actuator and the frequency of the oscillations produced by the brake force in the brake actuator.

The coefficients may be stored in a characteristic diagram in order, in the response of a failure of a speed information item of the superordinate control system, to use suitable speed-dependent brake parameters for each brake actuator.

If the characteristic diagram is advantageously adapted continuously, that is to say, for example, with each service braking operation, changes of the brake system as a result of ageing and wear can be taken into account in a simple manner.

In the event of an interruption of the communication, the control unit can establish the speed of the rail vehicle from the detected brake force produced, the oscillations produced by the brake force in the brake actuator and the coefficients stored in the characteristic diagram and can consequently determine a suitable brake force to be applied in order to carry out a speed-dependent brake operation.

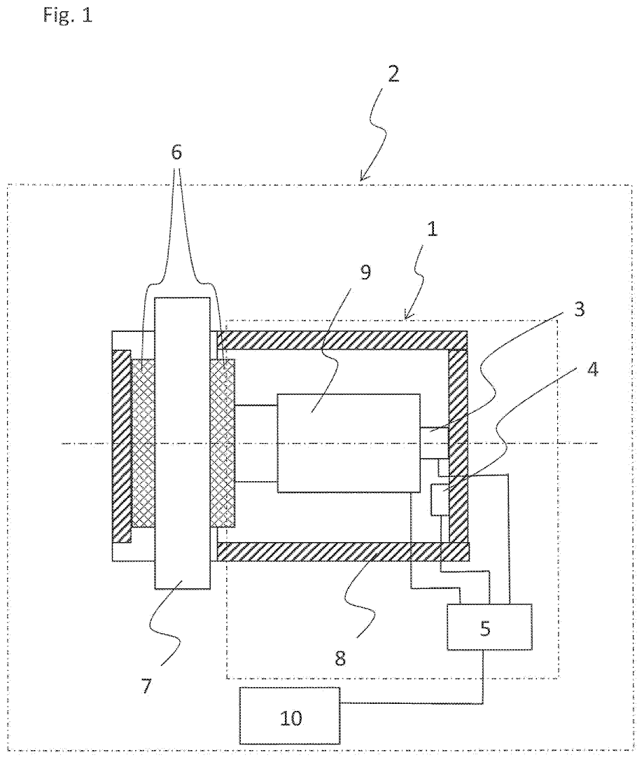

FIG. 1 schematically illustrates a rail vehicle 2 which has a brake actuator 1. The brake actuator 1 is associated in each case with a brake of the rail vehicle 2 which is illustrated in this instance as a brake disk 7. Alternatively, however, it is not absolutely necessary for a brake actuator 1 according to the disclosed embodiments to be associated with each brake.

The brake actuator 1 has a sensor for detecting a brake force 3 using which a brake force produced in the brake actuator 1 is detected. Furthermore, the brake actuator 1 has a sensor for detecting oscillations 4 using which oscillations produced by the brake force in the brake actuator 1 are detected. The sensor for detecting a brake force 3 and the sensor for detecting oscillations 4 can alternatively also be constructed as a single sensor, wherein this can then be arranged at the location at which the sensor for detecting a brake force 3 is illustrated. Consequently, both the brake force produced and the oscillations produced by the brake force can then be detected.

Furthermore, the brake actuator 1 has a control unit 5. The sensor for detecting a brake force 3 and the sensor for detecting oscillations 4 are connected to the control unit 5. The control unit 5 is configured to produce a relationship of a speed of the rail vehicle 2 with the brake force produced and a frequency of the oscillations produced by the brake force. In the event of a stoppage of the rail vehicle, the control unit 6 optionally produces and transmits a stop signal. Furthermore, the control unit 5 is configured to establish portions of the frequency of the oscillations produced by the brake force via a calculation of correlation factors via a calculation of the standard deviation, a “fast Fourier transformation” (FFT) or a “discrete Fourier transformation” (DFT).

The brake actuator 1 further has a pressing component 6, for example, a brake liner. This pressing component 6 is pressed against the brake disk 7. At the opposite side with respect to the brake disk 7, another pressing component 6 is illustrated in order to clamp the brake disk 7 therebetween and to be able to brake. To this end, the brake has a brake caliper 8 which may be displaceable with respect to the brake disk 7.

In the brake caliper 8, there is further provided a brake force generator 9 which in this instance is illustrated between one of the pressing components 6 and the sensor for detecting a brake force 3. The brake force generator 9 is, for example, a compressed air cylinder.

During normal operation, the brake actuator 1 is connected to a superordinate control system 10 which provides a speed signal of the rail vehicle 2. The normal operation is an operation without disruption, such as, for example, an interruption of a communication between the control unit 5 and the superordinate control system 10 so that no speed signal can be provided for the control unit 6.

During operation, the control unit 5 during service braking operations can detect the brake force produced in the brake actuator 1. Furthermore, the control device 5 detects the oscillations produced by the brake force in the brake actuator 1. The oscillations produced by the brake force in the brake actuator 1 originate from oscillations resulting from the pressing component 6 pressing on the brake disk 7 or from an imbalance of the brake disk 7. The control unit 5 then produces the relationship of the speed of the rail vehicle 2 with the brake force produced and the frequency of the oscillations produced by the brake force in the brake actuator 1. Portions of the frequency are established via the calculation of the correlation factors via the calculation of the standard deviation, the “fast Fourier transformation” (FFT) or the “discrete Fourier transformation” (DFT). From the calculations, coefficients which are then stored in the control unit 5 in a characteristic diagram are determined. The characteristic diagram is continuously adapted during service braking operations.

The speed of the rail vehicle 2 is provided by the superordinate control system 10 and converted by the control unit 5 into a rotation speed of the brake disk 7.

The control unit 5 may further transmit a stop signal during a stoppage of the rail vehicle 2.

In the event of an interruption of the communication between the control unit 5 and the superordinate control system 10, the speed of the rail vehicle 2 can be established from the detected brake force, the oscillations produced by the brake force and the coefficients stored in the characteristic diagram and, in spite of the interruption of the communication, a speed-dependent braking operation can be carried out.

All of the features set out in the description, the following claims and the drawings may be significant to the disclosed embodiments both individually and in any combination with each other.

### LIST OF REFERENCE NUMERALS

1 Brake actuator
2 Rail vehicle
3 Sensor for detecting a brake force
4 Sensor for detecting oscillations
5 Control unit
6 Pressing component
7 Brake disk
8 Brake caliper
9 Brake force generator
10 Superordinate control system

1. A brake actuator for a rail vehicle, the brake actuator comprising:
a sensor for detecting a brake force produced in the brake actuator,
a sensor for detecting oscillations produced by the brake force in the brake actuator; and
a control unit configured to produce a relationship of a speed of the rail vehicle with the brake force produced and a frequency of the oscillations produced by the brake force.

2. The brake actuator of claim 1, wherein the brake actuator has a pressing component which is configured to be pressed against a brake disk.

3. The brake actuator of claim 1, wherein the sensor for detecting the brake force produced in the brake actuator and the sensor for detecting oscillations produced by the brake force in the brake actuator are constructed as a single sensor.

4. The brake actuator of claim 1, wherein the control unit is connected during normal operation to a superordinate control system which is configured to provide a speed signal of the rail vehicle.

5. The brake actuator of claim 1, wherein the control unit is configured to produce a stop signal in the event of a stoppage of the rail vehicle (2).

6. The brake actuator of claim 1, wherein the control unit is configured to establish portions of the frequency via a calculation of correlation factors via a calculation of the standard deviation, a fast Fourier transformation or a discrete Fourier transformation.

7. A method for determining a speed of a rail vehicle with a brake actuator, the method comprising:
detecting a brake force produced in the brake actuator;
detecting oscillations produced by the brake force in the brake actuator; and
producing a relationship of the speed of the rail vehicle with the brake force produced and a frequency of the oscillations produced by the brake force.

8. The method of claim 7, wherein the speed is provided by a superordinate control system.

9. The method of claim 7, wherein the speed of the rail vehicle is converted into a rotation speed of a brake disk.

10. The method of claim 7, wherein the method is carried out during service braking operations.

11. The method of claim 7, wherein a stop signal is transmitted in the event of a stoppage of the rail vehicle.

12. The method of claim 7, wherein portions of the frequency are established via a calculation of the correlation factors via the calculation of the standard deviation, the fast Fourier transformation or the discrete Fourier transformation.

13. The method of claim 12, further comprising:
determining coefficients from the correlation factors; and
storing the coefficients in a characteristic diagram.

14. The method of claim 13, wherein the characteristic diagram is continuously adapted.

15. The method of claim 13, wherein the control unit, in response to the event of an interruption of a communication, establishes the speed from the detected brake force produced, the oscillations produced by the brake force and the coefficients stored in the characteristic diagram.
